(19) United States
(12) Patent Application Publication
(10) Pub. No.: US 2025/0007211 A1
(43) Pub. Date: Jan. 2, 2025

(54) Electrical Connector

(71) Applicant: Tyco Electronics (Shanghai) Co., Ltd., Shanghai (CN)

(72) Inventors: Bo (Leo) Chen, Shanghai (CN); Hongbo (Daniel) Zhang, Shanghai (CN)

(73) Assignee: Tyco Electronics (Shanghai) Co., Ltd., Shanghai (CN)

(21) Appl. No.: 18/758,592

(22) Filed: Jun. 28, 2024

(30) Foreign Application Priority Data
Jun. 30, 2023 (CN) 202310800030.X

(51) Int. Cl. H01R 13/627; H01R 12/77; H01R 12/79

(52) U.S. Cl. CPC H01R 13/627; H01R 12/774; H01R 12/79

(57) ABSTRACT

An electrical connector comprises a body, a terminal, and a cover. The body includes a receiving cavity in which the terminal is arranged. The terminal defines a contract portion and a pre-pressing portion. The cover is assembled onto the body and defines a pre-pressing groove. The pre-pressing portion abuts against the pre-pressing groove with the cover assembled onto the body.

### CROSS-REFERENCE TO RELATED APPLICATION

This application claims the benefit of Chinese Patent Application No. 202310800030.X filed on Jun. 30, 2023, in the State Intellectual Property Office of China, the whole disclosure of which is incorporated herein by reference.

### FIELD OF THE INVENTION

Embodiments of the present disclosure relate to electronic connection accessories and, more particularly, to an electrical connector with a pre-pressing structure.

### BACKGROUND

An electrical connector is a conductor device that bridges two conductors in a circuit so that current or signals can flow from one conductor to the other. For example, an electrical connector may be implemented to provide a detachable interface to connect two sub-electronic systems. In this way, a connector is a component used to achieve electrical connections between electronic circuits, devices and/or elements.

Known electrical connectors include flexible printed circuit board (FPC) connectors, which can be used for electrical connection of electronic devices such as liquid crystal displays, scanners, computer host boards, telecommunication cards, memories, and removable hard disks. With the development of mobile devices in recent years, FPC connectors are widely used in mobile devices such as audio, digital machines, cameras, and mobile phones, and have a promising development potential given the large market.

A flexible flat cable (FFC) is a component for signal transmission, which has the advantages of high flexibility and high signal transmission. Therefore, it is widely used in many electronic products. The flexible flat cable is used in conjunction with an electrical connector and associated terminals to serve as an FFC connector which can transmit signals from one end to the other.

Generally, electrical terminals have very high requirements on the spacing and height of such products. However, the existing FPC connectors and other similar products are easy to deform during assembly, packaging, and transportation. Such deformation adversely affects the height and position of the terminal, and further results in poor contact during the use of the product.

### SUMMARY

According to an embodiment of the present disclosure, an electrical connector comprises a body, a terminal, and a cover. The body includes a receiving cavity in which the terminal is arranged. The terminal defines a contract portion and a pre-pressing portion. The cover is assembled onto the body and defines a pre-pressing groove. The pre-pressing portion abuts against the pre-pressing groove with the cover assembled onto the body.

### BRIEF DESCRIPTION OF THE DRAWINGS

The invention will now be described by way of example with reference to the accompanying Figures, of which:

FIG. 1 is an exploded view of an electrical connector according to an embodiment of the present disclosure;

FIG. 2 is a schematic structural view of a second cover according to an embodiment of the present disclosure;

FIG. 3 is an enlarged view of the region A in FIG. 2;

FIG. 4 is a schematic diagram of the operating principle of a pre-pressing structure of the electrical connector according to an embodiment of the present disclosure;

FIG. 5 is an enlarged view of the region B in FIG. 4;

FIG. 6 is another schematic diagram of the operating principle of the pre-pressing structure of the electrical connector according to an embodiment of the present disclosure;

FIG. 7 is an enlarged view of the region C in FIG. 6;

FIG. 8 is a schematic diagram of connecting the electrical connector according to an embodiment of the present disclosure with a conductive connecting element;

FIG. 9 is a schematic structural view of the electrical connector according to an embodiment of the present disclosure where the conductive connecting element is locked by an elastic latch of the electrical connector; and

FIG. 10 is a schematic structural view of the electrical connector according to an embodiment of the present disclosure where the conductive connecting element is unlocked by the elastic latch of the electrical connector.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

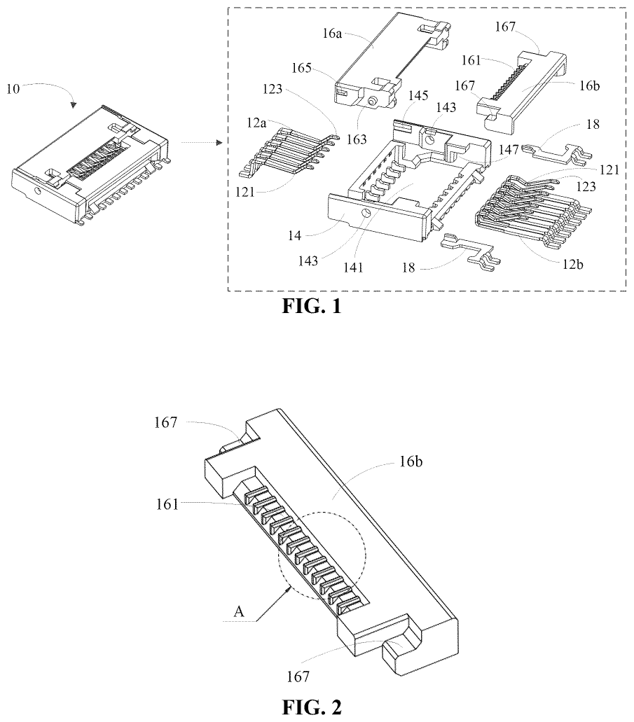

As shown in FIGS. 1-10, embodiments of the present disclosure provide an electrical connector 10. FIG. 1 is an exploded view of the electrical connector 10. The electrical connector 10 comprises a terminal 12, a body 14 and a cover 16. The terminal 12 comprises a contact portion 121 and a pre-pressing portion 123. The body 14 comprises a receiving cavity 141 for receiving the terminal 12. The cover 16 is assembled onto the body 14. The cover 16 comprises a pre-pressing groove 161. The pre-pressing portion 123 is adapted to be abutted against the pre-pressing groove 161.

In some examples, the cover 16 includes a first cover 16a and a second cover 16b. As shown in FIG. 1, the first cover 16a is rotatably connected to the body 14. In some examples, two sides of the first cover 16a are each provided with a rotating connection portion 163, and accordingly, two sides of the body 14 are each provided with a rotating connection hole 143. The first cover 16a is rotatably connected to the body 14 via the rotating connection portion 163 and the rotating connection hole 143. In some examples, the first cover 16a further comprises an engaging portion 165, and accordingly, the body 14 is provided with a matched engaging groove 145. The first cover 16a is fixedly connected to the body 14 via the engaging portion 165 and the engaging groove 145 by rotating and pressing the first cover 16a downward to the body 14. Optionally, the positions of the rotating connection portion 163 and the rotating connection hole 143 are interchangeable, and the positions of the engaging portion 165 and the engaging groove 145 are interchangeable.

The contact portion 121 is a structure bent toward a bottom of the receiving cavity 141, and the pre-pressing portion 123 is a structure bent away from the bottom of the receiving cavity 141. The bent structure of the contact portion 121 is such configured that the distance between its lower surface and the bottom of the receiving cavity is the smallest, so that a jig 30 first contacts the contact portion after insertion and forces the contact portion to elastically deform to drive the pre-pressing portion to move. The bent structure of the pre-pressing portion 123 facilitates the lapping between the pre-pressing portion 123 and the pre-pressing groove 161 and ensures the pre-pressing effect. In some examples, the terminal 12 comprises a first terminals 12a and a second terminals 12b, and the pre-pressing groove 161 comprises a first pre-pressing grooves for pre-pressing the first terminals 12a and a second pre-pressing grooves for pre-pressing the second terminals 12b. By way of example, the first terminals 12a and the second terminals 12b are alternatingly arranged at equal intervals, and accordingly, the first and second pre-pressing grooves are alternatingly arranged at equal intervals. Preferably, the first and second prepressing grooves are of the same structure.

The first end of each first terminal 12a and the first end of each second terminal 12b are connected to an externally inserted conductive connecting element 20. The second end of each first terminal 12a and the second end of each second terminal 12b are respectively arranged at two ends of the body 14, so as to achieve the electrical connection between the conductive connecting element 20 and other electrical elements. In some examples, the first end of each first terminal 12a and the first end of each second terminal 12b are the contact portion 121 of the terminal 12. In this way, the terminal 12 is electrically connected with the externally inserted conductive connecting element via the contact portion 121. The conductive connecting element 20 is a flexible printed circuit board or a flat cable. The contact portion 121 is pushed to move to drive the pre-pressing portion 123 to move away from the pre-pressing groove 161 when the conductive connecting element is inserted.

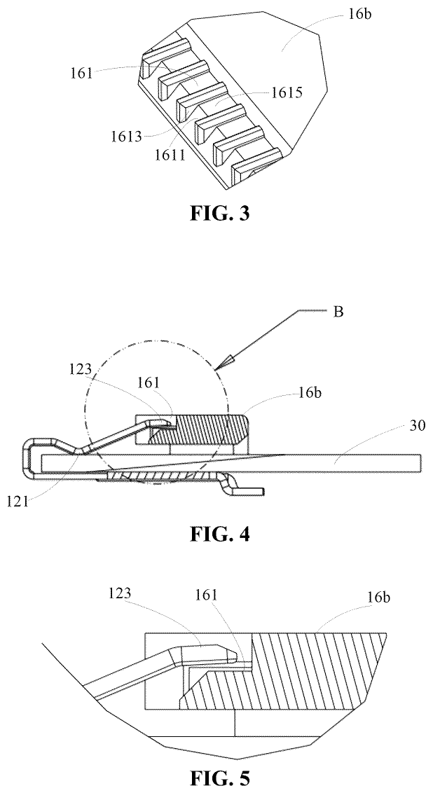

In some examples, the second cover 16b comprises the pre-pressing groove 161 for cooperative installation with the pre-pressing portion 123. FIG. 2 is a schematic structural view of the second cover 16b. FIG. 3 is an enlarged view of the region A in FIG. 2. As shown in FIGS. 2 and 3, a plurality of the pre-pressing grooves 161 are arranged in an array on an upper surface of the second cover 16b. The pre-pressing grooves 161 are evenly spaced and match the terminals in position, quantity, width, and height, so as to achieve pre-pressing for the terminals, provide a stable terminal gap, and ensure the height and position of the terminals.

Each of the pre-pressing grooves 161 may comprise a bevel 1611, side walls 1613, and a horizontal surface 1615. The bevel 1611 is designed to reduce the possibility of interference between the second cover 16b and the terminal during installation of the second cover, thereby improving assembly quality and efficiency. The side walls 1613 achieve isolation of different terminals to avoid short circuit conditions. The pre-pressing portion 123 is oriented upwards, and after the second cover is inserted, the pre-pressing portion is moved downward and lapped over the horizontal surface 1615.

In the exemplary embodiments, the second cover 16b comprises an insertion portion 167, and the body 14 comprises an insertion position 147. The second cover 16b and the body 14 are connected by horizontally inserting the insertion portion 167 into the insertion position 147. In some examples, the second cover 16b and the body 14 jointly define an insertion slot 149 for insertion of the conductive connecting element 20, such that the conductive connecting element is electrically connected with the terminal 12. Preferably, the insertion space of the insertion slot 149 is the same as the operation space in which the jig is inserted to operate the contact portion so as to drive the pre-pressing portion to move.

Further, the present disclosure describes in detail the working principle of the pre-pressing structure in FIGS. 4-7. As shown in FIG. 4, a jig 30 is inserted to below the lower surface of the terminal 12. The thickness of the jig 30 is greater than the preset minimum height of the operation space, so the jig 30 acts on the contact portion 121 to force the contact portion to elastically deform. Then, the contact portion 121 moves upward, thereby driving the pre-pressing portion 123 to move upward. FIG. 5 is an enlarged view of the region B in FIG. 4. FIG. 5 illustrates that when the jig 30 is inserted, the pre-pressing portion 123 moves upward. A certain space is reserved between the pre-pressing groove 161 and the pre-pressing portion 123 after the second cover 16b is inserted into the body 14, so as to avoid interference between the second cover 16b and the terminal during the insertion of the second cover 16b.

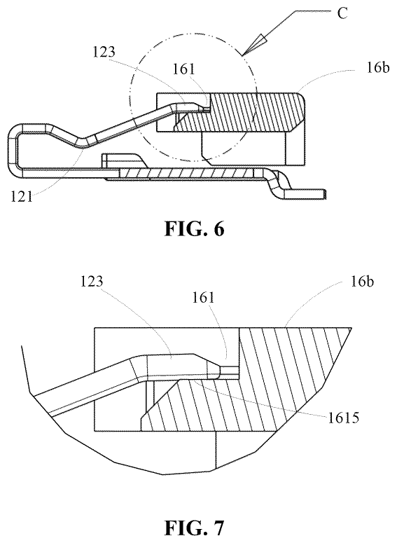

As shown in FIG. 6, after the jig 30 is removed, the contact portion 121 recovers from the elastic deformation and reverts back to the original state. This drives the pre-pressing portion 123 to move downward and fit into the pre-pressing groove 161 of the second cover 16b, thereby the pre-pressing groove 161 achieves the pre-pressing of the terminal. FIG. 7 is an enlarged view of the region C in FIG. 6. FIG. 7 shows that after the jig 30 is taken out, the pre-pressing portion 123 fits into the pre-pressing groove 161, and the pre-pressing portion 123 laps over the horizontal surface 1615 of the pre-pressing groove 161 without gap.

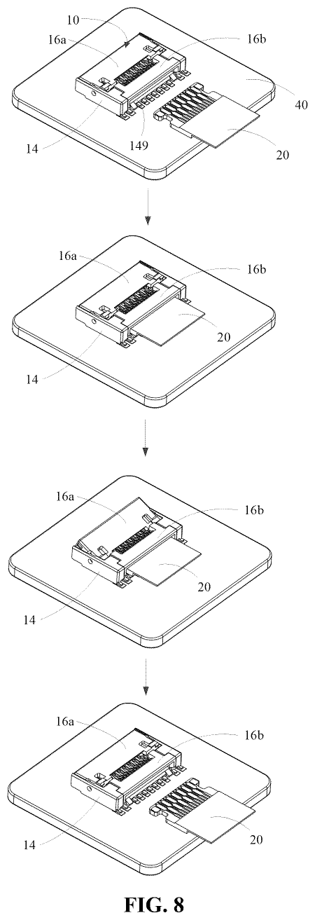

FIG. 8 is a schematic diagram of connecting the electrical connector 10 with the conductive connecting element 20. Specifically, the electrical connector 10 comprises an elastic latch 18. The conductive connecting element 20 is locked in a preset position by the elastic latch 18 after the conductive connecting element is inserted into the insertion slot 149. Moreover, the electrical connector 10 in FIG. 8 is electrically connected to a PCB 40. Therefore, the conductive connecting element 20 is electrically connected to the PCB 40 after it is inserted into the electrical connector 10. When the first cover 16a is rotated relative to the body 14 to open, the first cover 16a acts on the elastic latch 18, forces the elastic latch 18 to elastically deform and drives a snap portion 181 of the elastic latch 18 to move, thereby unlocking the conductive connecting element 20. The snap portion 181 has a bevel 1811 configured to guide an insertion path of the conductive connecting element 20 during the insertion of the conductive connecting element. In some examples, the body 14, the terminal 12 and the elastic latch 18 are together formed by injection molding.

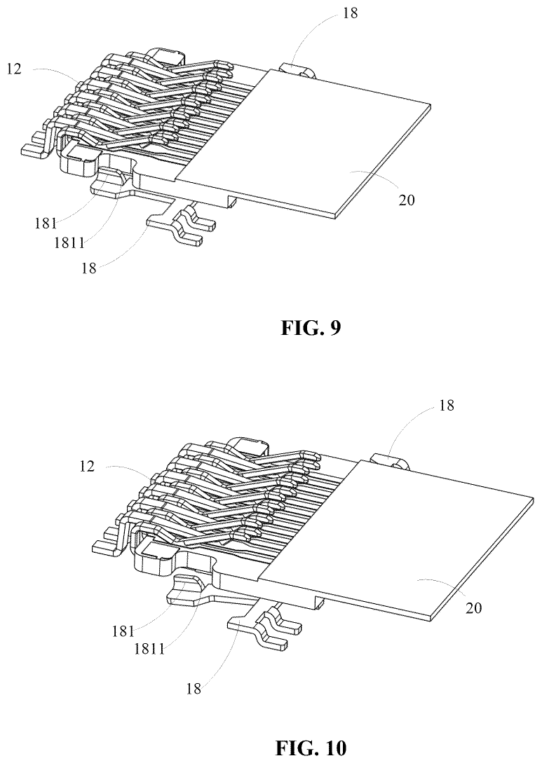

FIGS. 9 and 10 are schematic diagrams of the working principle of the elastic latch in the electrical connector. Specifically, FIG. 9 is a schematic structural view showing the conductive connecting element is locked by the elastic latch. FIG. 10 is a schematic structural view showing the conductive connecting element is unlocked by the elastic latch. In FIG. 9, after the conductive connecting element 20 is inserted into the insertion slot, the snap portion 181 of the elastic latch 18 snaps into a corresponding snap position of the conductive connecting element 20, thereby locking the conductive connecting element 20. Even if the conductive connecting element is disturbed by an unexpected external force, the conductive connecting element cannot be disconnected from the terminal 12 due to the stop action of the snap portion 181. In FIG. 10, the elastic latch 18 is elastically deformed due to the rotating push from the first cover 16a, and the snap portion 181 is disengaged from the snap position of the conductive connecting element 20. At this time, the conductive connecting element 20 can be disconnected from the terminal with an outward pulling force.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector, comprising:
a body comprising a receiving cavity;
a terminal arranged in the receiving cavity and including a contact portion and a pre-pressing portion; and
a cover assembled onto the body, the cover defining a pre-pressing groove, the pre-pressing portion adapted to abut against the pre-pressing groove.

2. The electrical connector according to claim 1, wherein the cover comprises a first cover and a second cover, the first cover is rotatably connected to the body, and the second cover includes the pre-pressing groove engaging with the pre-pressing portion.

3. The electrical connector according to claim 2, wherein a plurality of the pre-pressing grooves are arranged in an array on an upper surface of the second cover.

4. The electrical connector according to claim 2, wherein the second cover and the body together define an insertion slot adapted to receive a conductive connecting element, such that the conductive connecting element is electrically connectable with the terminal.

5. The electrical connector according to claim 4, wherein the conductive connecting element is a flexible printed circuit board or a flat cable.

6. The electrical connector according to claim 4, wherein the contact portion is biased to drive the pre-pressing portion to move away from the pre-pressing groove when the conductive connecting element is inserted into the insertion slot.

7. The electrical connector according to claim 4, further comprising an elastic latch fixed inside the receiving cavity and defining a snap portion.

8. The electrical connector according to claim 7, wherein the elastic latch is adapted to lock a conductive connecting element in a preset position after insertion of the conductive connecting element into the insertion slot.

9. The electrical connector according to claim 8, wherein the first cover is operable to rotate relative to the body and to bias the elastic latch to elastically deform and drive the snap portion to move, so as to unlock the conductive connecting element.

10. The electrical connector according to claim 8, wherein the snap portion has a bevel adapted to guide an insertion path of the conductive connecting element during the insertion of the conductive connecting element.

11. The electrical connector according to claim 1, wherein the contact portion is a structure curved toward a bottom of the receiving cavity.

12. The electrical connector according to claim 11, wherein and the pre-pressing portion is a structure curved away from the bottom of the receiving cavity.

13. The electrical connector according to claim 1, wherein the terminal is electrically connectable to a conductive connecting element via the contact portion.

14. The electrical connector according to claim 1, wherein the terminal includes a first terminal and a second terminal, and the pre-pressing groove includes a first pre-pressing groove for pre-pressing the first terminal and a second pre-pressing groove for pre-pressing the second terminal.

15. An electrical connector, comprising:
a body defining a receiving cavity;
a terminal arranged in the receiving cavity and including a contact portion and a pre-pressing portion; and
a first cover adapted to be assembled with the body and over the receiving cavity, the first cover defining a pre-pressing groove, the pre-pressing portion adapted to abut against the pre-pressing groove under an elastic return force of the pre-pressing portion.

16. The electrical connector according to claim 15, further comprising a second cover rotatably connected to the body.

17. The electrical connector according to claim 16, wherein the first cover and the body define an insertion slot therebetween adapted to receive a conductive connecting element.

18. The electrical connector according to claim 17, further comprising an elastic latch arranged within the receiving cavity and adapted to lock a conductive connecting element in a preset position after insertion of the conductive connecting element into the insertion slot.

19. The electrical connector according to claim 18, wherein the second cover is rotatable relative to the body and biases the elastic latch to elastically deform and unlock the conductive connecting element from the insertion slot.

20. The electrical connector according to claim 17, wherein the terminal is electrically connectable to the conductive connecting element via the contact portion.
